(19) United States
(12) Patent Application Publication
(10) Pub. No.: US 2014/0019878 A1
(43) Pub. Date: Jan. 16, 2014

(54) SYSTEM AND METHOD FOR REFLECTING PLAYER EMOTIONAL STATE IN AN IN-GAME CHARACTER

(71) Applicant: Evgeny OLOMSKIY, Vladivostok (RU)

(72) Inventor: Evgeny OLOMSKIY, Vladivostok (RU)

(73) Assignee: KamaGames Ltd., Limassol (CY)

(21) Appl. No.: 13/547,953

(22) Filed: Jul. 12, 2012

(51) Int. Cl. G06F 3/01; G06F 15/16

(52) U.S. Cl. 715/753

(57) ABSTRACT

A virtual space is provided to users, including a first user and a second user. The virtual space, or instances of the virtual space, may be used to enable users to participate in an activity such as, e.g., a game. Users are represented by avatars in views of the virtual space. A set of animations of a first avatar, the animations corresponding to different emotional states being reflected through the first avatar, is offered for selection by the first user. Upon receipt of a selection of a first animation from the first user, the first animation of the first avatar is presented to the second user.

### FIELD

The disclosure relates to a system and method for reflecting emotional states and/or conveying other non-verbal information through avatars and/or in-game characters that represent users and/or players within a virtual space and/or online game. Different emotional states and/or other non-verbal information may correspond to different animations of the avatars.

### BACKGROUND

Virtual spaces that enable users to participate in games and/or other online (social) activities are known. Virtual spaces that enable users to play games, including card games and/or other turn-based games, are known. Virtual spaces that present views of avatars to represent users are known. Animations of avatars, for example to depict action, and/or an event within a virtual space, are known.

### SUMMARY

One aspect of the disclosure relates to providing a virtual space to users. A virtual space may be used to enable users to participate in an online game and/or other online (social) activity, collectively referred to herein as “a game”. Online games may include, by way of non-limiting example, card games, dice games, role-playing games, and/or other games. “Activities” may refer to either games or other applications, such as, by way of non-limiting example, professional applications, multi-media applications, business applications, medical applications, and/or other non-game applications. One aspect of the disclosure relates to systems and methods for users to reflect emotional state of users through animations of avatars.

In some implementations, a system configured to reflect emotional state of users and/or convey other non-verbal information through avatars may include a server and one or more client computing platforms configured to communicate in a client/server fashion. The users may include a first user, a second user, and so forth. Individual client computing platforms may be associated with individual users. A first client computing platform may be associated with the first user, a second client computing platform may be associated with a second user, and so forth. View information of a virtual space may be transmitted and/or presented to users on client computing platforms. Users may be able to interact with the virtual space and/or participate in games through inputs to the client computing platforms. The system and/or the client computing platforms may include user interfaces that may have electronic displays, and may be configured to execute one or more of a virtual space module, an offer module, a selection module, an analysis module, and/or other modules. Individual ones of the client computing platforms may be interchangeably referred to herein as computing devices.

For a particular user, an activity may be displayed on and/or presented through a user interface, an electronic display, and/or a touch screen of a computing device.

The virtual space module may be configured to determine view information for transmissions to client computing platforms. The transmissions may facilitate presentations of views of avatars representing the users, e.g. within a virtual space. A first avatar may represent the first user; a second avatar may represent the second user, and so forth. The view information may include any information needed to present activities and/or events to users, or any subset of such information. The view information may enable participation and/or interaction of users within a virtual space.

For a particular user, the virtual space module may be configured to determine view information defining a particular view of the virtual space that includes an avatar representing the particular user.

The offer module may be configured to determine animations of avatars to offer to users for selection. The animations of the avatars may correspond to emotional states being reflected through the avatars. The emotional states being reflected through animations of avatars may include, by way of non-limiting example, one or more of happiness, sadness, bashfulness, fear, surprise, excitement, anger, agitation, disgust, affection, boredom, disappointment, envy, hope, panic, and/or other emotional states. For a particular user being represented by a particular avatar, the offer module may be configured to determine a set of animations of the particular avatar. The set of animations may be offered and/or presented to the particular user for selection by the particular user. For example, the particular user may be able to interact with the offer module through inputs to a particular client computing platform that is associated with the particular user.

The selection module may be configured to receive selections by users. The received selections may indicate animations of avatars. For example, for a particular user being represented by a particular avatar, the selection module may be configured to receive a selection by the particular user, e.g. through an interface presented on a client computing platform, such that the selection indicates a particular animation of the particular avatar. Responsive to receipt of a selection, the selected animation may be presented. For example, the selection module may receive a selection indicating a first animation of the first avatar, selected by the first user. Responsive to receipt of this selection, the virtual space module may be further configured to determine view information for transmission to the second client computing platform such that the transmission facilitates presentation of the first animation of the first avatar to the second user, through the second client computing platform. Alternatively, and/or simultaneously, view information for transmission to other client computing platforms may be determined.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to reflect emotional states of users through avatars.

FIG. 2 illustrates a method for reflecting emotional states of users through avatars.

FIG. 3 illustrates a view of an exemplary virtual space user interface, as presented to a user, which facilitates interaction between the user and a system configured to reflect emotional states through avatars.

### DETAILED DESCRIPTION

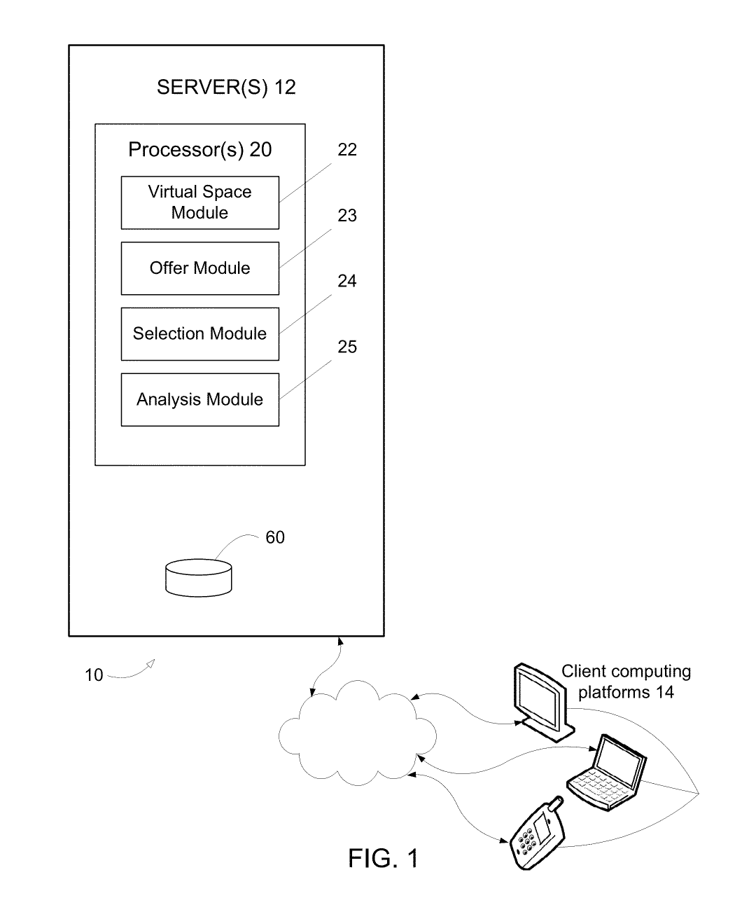

FIG. 1 illustrates a system 100 that may be configured to provide a virtual space to users. System 100 may be configured such that the users participate in one or more games, activities, and/or applications within a virtual space and/or pertaining to a virtual space. By virtue of using system 100, users may have the ability to reflect emotional states and/or other non-verbal information through avatars. This may enhance the online experience for participating users. Providing the virtual space may include hosting the virtual space over a network.

In some implementations, system 100 may include one or more servers 12, hereinafter simply referred to as server 12. Server 12 may be configured to communicate with one or more client computing platforms 14 (hereinafter simply referred to as client computing platform 14 or client computing platforms 14) according to, e.g., a client/server architecture. Users may access system 100 and/or the virtual space via client computing platforms 14.

As depicted in FIG. 1, server 12 may include one or more processors 20, electronic memory 50, and/or other components. One or more processors 20 may be configured to execute one or more of a virtual space module 22, an offer module 23, a selection module 24, an analysis module 25, and/or other modules.

The client computing platforms 14 may be configured to enable users to interface with system 100 and/or server 12, and/or provide other functionality attributed herein to client computing platforms 14. For example, the client computing platforms 14 may receive view information transmitted from server 12 and/or present views of the virtual space based on the transmitted view information. This may facilitate participation by the users of client computing platforms 14 in the activity taking place in the virtual space. By way of non-limiting example, client computing platform 14 may include one or more of a desktop computer, a laptop computer, a handheld computer, a tablet computing platform, a NetBook, a Smartphone, a gaming console, and/or other computing platforms.

Virtual space module 22 of server 12 in FIG. 1 may be configured to provide one or more virtual spaces to users via client computing platforms 14. As used herein, a “virtual space” may include a virtual environment, one or more interactive, electronic social media, one or more social networks, and/or other virtual environments. A virtual space may refer to a virtual environment in which a game is being played or an activity takes place that involves a plurality of users. Providing a virtual environment to users may include hosting, supporting, and/or executing one or more instances of a virtual environment, determining view information defining and/or representing the virtual environment (e.g., from one or more instances) for the users (e.g., individually and/or collectively), transmitting the view information to client computing platforms 14 associated with the users to facilitate views of the virtual environment being presented to the users, and/or other activities.

In some implementations, in views of the virtual space, avatars may represent users as an activity is taking place, a game is played, other online activities are performed, and/or other applications are being used (collectively referred to herein as activities) by and/or among the users in the virtual space. In some implementations, the multiple activities are instances of the same activity taking place with different sets of users.

A virtual space may comprise a simulated space that is accessible by users via clients (e.g., client computing platforms 14) that present the views of the virtual space to a user. The simulated space may have a simulated physical layout, express ongoing real-time interaction by one or more users, and/or be constrained by simulated physics that governs interactions between virtual objects in the simulated space. In some instances, the simulated physical layout may be a 2-dimensional layout. Alternatively, and/or simultaneously, in some instances, the simulated physical layout may be a 3-dimensional layout.

Virtual space module 22 of server 12 in FIG. 1 may be configured to express the virtual space in a relatively limited manner. For example, views of the virtual space presented to the users may be selected from a limited set of graphics depicting an event in a given place within the virtual space. The views may include additional content (e.g., text, audio, pre-stored video content, movable icons, avatars, and/or other content) that describes particulars of the current state of the space, beyond the relatively generic graphics. For example, a view of the virtual space may depict a card table and/or a non-player character that are static (or change relatively little) visually in views of virtual space. Icons representing game components (e.g., game pieces, playing cards, dice, and/or other game components) may change and/or move within the views of the virtual space to depict a game being played within the virtual space. Such limited representation of the virtual space may reduce the cost of hosting the virtual space in terms of processing, storage, communication bandwidth, and/or other computing resource (e.g., on server 12 and/or client computing platforms 14). Other expressions of individual places within the virtual space are contemplated.

Within the instance(s) of the virtual space (or other virtual environment) executed by virtual space module 22, users may control avatars to interact with the virtual space and/or each other. As used herein, the term “avatar” may refer to an object (or group of objects) present in the virtual space that represents an individual user. The avatar may be controlled by the user who is associated with the avatar. The avatar representing a given user may be created and/or customized by the given user. The user may have an “inventory” of virtual goods and/or currency that the user can use (e.g., by manipulation of an avatar or other user controlled element, and/or other items), display, gift, and/or otherwise interact with within the virtual space. Avatars may depict anthropomorphic characters. Avatars may include bodies and heads, for example an entire anthropomorphic character.

The users may participate in the virtual space by controlling one or more of the available user controlled elements in the virtual space (e.g., game elements, avatars, and/or other elements). Control may be exercised through control inputs and/or commands input by the users through client computing platforms 14.

It will be appreciated that the description herein of virtual space module 22 providing a virtual space to a set of users in which an activity is being used by the set of users is not intended to be limiting. For example, virtual space module 22 may be configured to provide a plurality of different virtual spaces to a plurality of different sets of users. The individual sets of users may be participating in different instances of the activity within the individual virtual spaces. The concepts described herein with respect to the individual virtual space and activity should be extendible to implementations in which a plurality of different virtual spaces are being used to conduct a plurality of different instances of the activity (e.g., between different sets of users).

Offer module 23 may be configured to determine animations of avatars to offer to users for selection. The animations of the avatars may correspond to emotional states being reflected through the avatars. For a particular user being represented by a particular avatar, offer module 23 may be configured to determine a set of animations of the particular avatar. The set of animations may be offered and/or presented to the particular user for selection by the particular user. For example, the particular user may be able to interact with offer module 23 through inputs to a particular client computing platform 14 that is associated with the particular user.

Selection module 24 may be configured to receive selections by users. The received selections may indicate animations of avatars. For example, for a particular user being represented by a particular avatar, selection module 24 may be configured to receive a selection by the particular user, e.g. through an interface presented on client computing platform 14, such that the selection indicates a particular animation of the particular avatar. Responsive to receipt of a selection, the selected animation may be presented. For example, selection module 24 may receive a selection indicating a first animation of the first avatar, selected by the first user associated with a first client computing platform 14. Responsive to receipt of this selection, virtual space module 22 may be further configured to determine view information for transmission to a second client computing platform 14 such that the transmission facilitates presentation of the first animation of the first avatar to the second user, through second client computing platform 14. Alternatively, and/or simultaneously, view information for transmission to other client computing platforms 14 may be determined. By virtue of using system 100, a user may reflect his/her own emotional state through an animation of an avatar such that other users are presented with the selected animation. Alternatively, and/or simultaneously, a user may convey other non-verbal information to other users.

Analysis module 25 may be configured to analyze transactions and/or events, e.g., within one or more virtual spaces. Through analysis by analysis module 25 a set of animations of the avatars may be determined based on the transactions and/or events. Responsive to analysis by analysis module 25, determinations by offer module 23 may be based on results from analysis module 25. For example, analysis may be based on prior selections by the first user. In some implementations, one or more selections that were recently (or more frequently) made by a user may affect analysis and/or determinations by analysis module 25 and/or offer module 23.

Analysis by analysis module 25 may be based on one or more algorithms. One or more of these algorithms may be based on a heuristic prediction of the likelihood of selection of individual animations for a particular avatar and/or user. In implementations of an algorithm that use a ranking for the available animations, prior selections by a user may increase the ranking of selected animations.

Algorithms may alternatively, and/or simultaneously, incorporate context of actions, transactions and/or events within one or more virtual spaces as they correspond to selections of animations by users. For example, if a user (repeatedly) selects a particular animation in response to a particular event, the algorithm may act/react correspondingly, for example by increasing the ranking and/or likelihood of the particular animation for related and/or similar events.

In some implementations, offer module 23 may be configured such that one or more available animations may be organized and/or ordered in a hierarchy such that more popular and/or more likely-to-be-selected animations may be accessed and/or selected more easily (for example through less user actions within a user interface) than less popular and/or less likely-to-be-selected animations. In some implementations, one or more available animations may be organized and/or ordered according to a common characteristic (e.g. childish, silly, aloof, sarcastic, and/or another characteristic which may be dependent on a mood) and/or personality type. For example, animations that correspond to a mostly introvert personality type may be separate and/or different from animations that correspond to a mostly extrovert personality type, even if both may include an animation corresponding to, e.g., happiness. Personality types may gradually range along one or more continuums, including a continuum that indicates how readily an avatar would initiate an action with another avatar. If the characteristic is related to a mood, the characteristic may be more variable and/or flexible than a personality type, which may change more gradually or slowly.

In some implementations, a user may select multiple animations that are mixed, blended, and/or otherwise combined when displaying the selection for presentation. For example, a user may select animations for both “happiness” and “affection” conjunctively.

In some implementations, a user may select which other avatar should be included in an animation. For example, a user may select an animation for “joy” or “celebration” to be presented with another avatar, such as a celebratory dance routine involving both avatars. In some implementations, the other avatar may be selected autonomously, for example based on current actions, transaction, and/or events within the virtual space. In some implementations, the likelihood of such an interaction may be based, at least in part, on the current mood, personality type, and/or other setting or configuration for the other avatar. In other words, it may take two to tango.

In some implementations, selection module 24 may be configured, e.g. responsive to configuration by a user, to autonomously select animations of avatars during use of the virtual space. Such configuration may pertain to independent aspects including, but not limited to, a selected common characteristic (e.g. childish, aloof, sarcastic), a selected activity/energy level (e.g. ranging from lethargic to hyper-active), and/or a selected personality type (e.g. introvert, extrovert) for a particular avatar. For example, in case of a first user and a first avatar, selection module 24 may autonomously select animations of the first avatar from a subset of available animations of the first avatar. Autonomous selection may be based on and/or react to actions, transaction, and/or events within a virtual space, e.g. as based on prior (manually selected) animations. Alternatively, and/or simultaneously, autonomous selection may be based on user configuration such as the selected activity/energy level that indicates how often autonomous selection should take place. In some implementations, the activity/energy level may be combined with one or more selected common characteristics and/or a selected personality type.

It is contemplated that autonomous selection may be based on one or more algorithms used in analysis module 25, information from analysis module 25, analysis of manually selected animations by a user, user configuration, and/or other information. System 100 may be configured to learn which animations a user may select under certain circumstances.

It will be appreciated that the described functionality of system 100 is not limited to the organization and/or structure of specific computer program modules. This functionality may be enabled and/or performed through fewer or more computer program modules. Specific features herein attributed to a particular computer program module may be integrated and/or combined within the functionality of one or more other computer program modules.

Turning back to FIG. 1, in some implementations, server 12 and client computing platforms 14 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server 12 and/or client computing platforms 14 may be connected and/or interface via some other configuration and/or mechanism.

A given client computing platform 14 may include one or more processors, an electronic display, electronic storage, a control interface, and/or other components. The one or more processors may be configured to execute computer program modules.

Server 12 may include communication lines, or ports to enable the exchange of information with a network and/or other computing platforms. The illustration of server 12 in FIG. 1 is not intended to be limiting. Server 12 may include a plurality of hardware, software, and/or firmware components operating together to provide the functionality attributed herein to server 12. For example, server 12 may be implemented “in the cloud” by a plurality of computing platforms operating together as server 12.

Electronic storage 50 may comprise electronic storage media that electronically stores information. The electronic storage media of electronic storage 50 may include one or both of system storage that is provided integrally (i.e., substantially non-removable) with server 12 and/or removable storage that is removably connectable to server 12 via, for example, a port (e.g., a USB port, a firewire port, etc.) or a drive (e.g., a disk drive, etc.). Electronic storage 50 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 50 may include one or more virtual storage resources (e.g., cloud storage, a virtual private network, and/or other virtual storage resources). Electronic storage 50 may store software algorithms, information determined by processor 20, information received from server 12, information received from client computing platforms 14, and/or other information that enables server 12 to function as described herein.

Processor(s) 20 is configured to provide information processing capabilities in server 12. As such, processor 20 may include one or more of a digital processor, an analog processor, a digital circuit designed to process information, an analog circuit designed to process information, a state machine, and/or other mechanisms for electronically processing information. Although processor 20 may be shown in FIG. 1 as a single entity for server 12, this is for illustrative purposes only. In some implementations, processor 20 may include a plurality of processing units. These processing units may be physically located within the same device, or processor 20 may represent processing functionality of a plurality of devices operating in coordination. Processor 20 may be configured to execute modules 22-25, and/or other modules. Processor 20 may be configured to execute modules by software; hardware; firmware; some combination of software, hardware, and/or firmware; and/or other mechanisms for configuring processing capabilities on processor 20.

It should be appreciated that although modules 22-25 are illustrated in FIG. 1 as being co-located within a single processing unit, in implementations in which processor 20 includes multiple processing units, one or more of modules 22-25 may be located remotely from the other modules. As a non-limiting example, some or all of the functionality attributed to modules 22-25 may be provided “in the cloud” by a plurality of processors connected through a network. The description of the functionality provided by the different modules 22-25 herein is for illustrative purposes, and is not intended to be limiting, as any of modules 22-25 may provide more or less functionality than is described. For example, one or more of modules 22-25 may be eliminated, and some or all of its functionality may be provided by other ones of modules 22-25. As another example, processor 20 may be configured to execute one or more additional modules that may perform some or all of the functionality attributed below to one of modules 22-25.

User interfaces of server 12 and/or client computing platform 14 may be configured to provide an interface between server 12 and/or client computing platform 14 and users through which the users can provide and/or receive information. This may enable data, results, and/or instructions and any other communicable items, collectively referred to as “information,” to be communicated within system 100. Examples of interface devices suitable for inclusion in user interfaces may include a keypad, buttons, switches, a keyboard, knobs, levers, a display screen, a touch screen, speakers, a microphone, an indicator light, an audible alarm, and a printer. Information may be provided to users in the form of auditory signals, visual signals, tactile signals, and/or other sensory signals.

It is to be understood that other communication techniques, either hard-wired or wireless, are also contemplated herein. Exemplary input devices and techniques adapted for use with client computing platform 14 may include, but are not limited to, an RS-232 port, RF link, an IR link, modem (telephone, cable, Ethernet, internet or other). In short, any technique for communicating information within system 100 is contemplated.

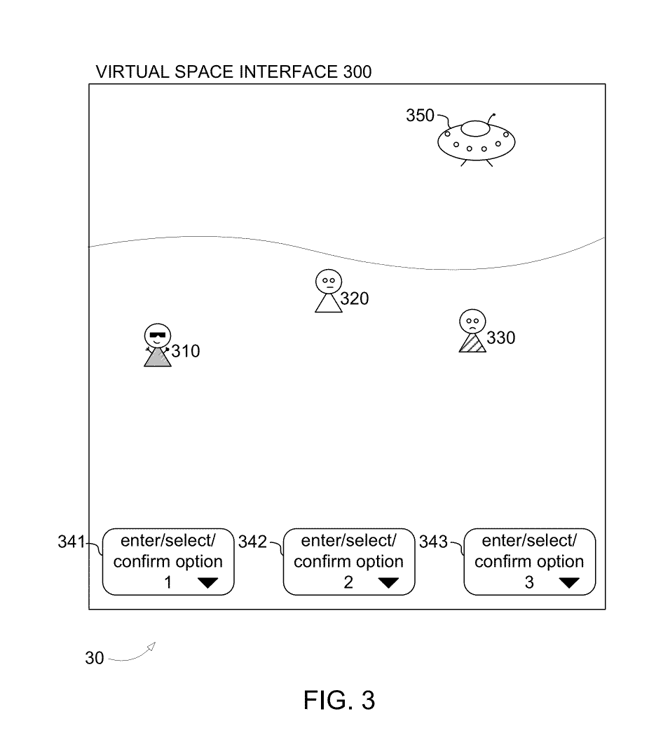

By way of illustration, FIG. 3 illustrates a view 30 of an exemplary virtual space user interface 300, as presented to a first user, which facilitates interaction between the first user and a system configured to reflect emotional states through avatars, as described herein. View 30 may include a first avatar 310 representing the first user, a second avatar 320 representing a second user, a third avatar representing a third user, game-wide interface element 350, user-specific interface elements 341-343, and/or other interface elements, components, and/or features. Game-wide interface element 350 may be, e.g., an object and/or a character that multiple users within the virtual space may interact with. User-specific interface elements 341-343 may be, e.g., objects, interfaces, fields, and/or other items that the first user may interact with, such as a menu of user-selectable options, animations, and/or actions for engaging the virtual space. Virtual space interface 300 may be configured to present information to the user viewing view 30 of the virtual space. Avatar 310 in FIG. 3 may be visible to multiple users within the virtual space.

Virtual space interface 300 may present an offered set of user-selectable animations of first avatar 310 and/or other avatars. The inputs received, e.g. by a selection module, may include one or more selections from an offered set of user-selectable options.

Interface elements 341-343 of virtual space interface 300 may be implemented as fields configured to receive entry, selection, and/or confirmation from a user. The fields may include one or more of a text entry field, a set of selectable menu items, a selectable field, and/or other fields configured to receive entry, selection, and/or confirmation from a user.

For example, field 341 may be related to a selection of the current emotional state to be reflected through avatar 310, and/or a corresponding animation. Once a selection has been made and/or confirmed, the view of interface 30 may reflect the selected option, and present the selected animation of avatar 310 to the first user as well as other users. Field 342, for example, may be related to a selection of a current characteristic or mood to be reflected through avatar 310, and/or a corresponding animation. Once a selection has been made and/or confirmed, the view of interface 30 (or the available selectable animations through another interface element and/or field) may reflect the selected characteristic and/or mood, and present one or more animations of avatar 310 to the first user as well as other users. Field 343, for example, may be related to a selection of a personality type or energy level to be reflected through avatar 310, and/or a corresponding animation. Once a selection has been made and/or confirmed, the view of interface 30 (or the available selectable animations through another interface element and/or field) may reflect the selected personality type and/or energy level, and present one or more animations of avatar 310 to the first user as well as other users.

Note that the foregoing examples are merely intended to be exemplary, and not limiting in any way. The use, spatial arrangement, number, and described functionality of the user-selectable fields in virtual space interface 300 is likewise exemplary, and not limiting in any way. Any of the preceding functions described through particular user-selectable fields in virtual space interface 300 may be attributed to other elements of a user interface.

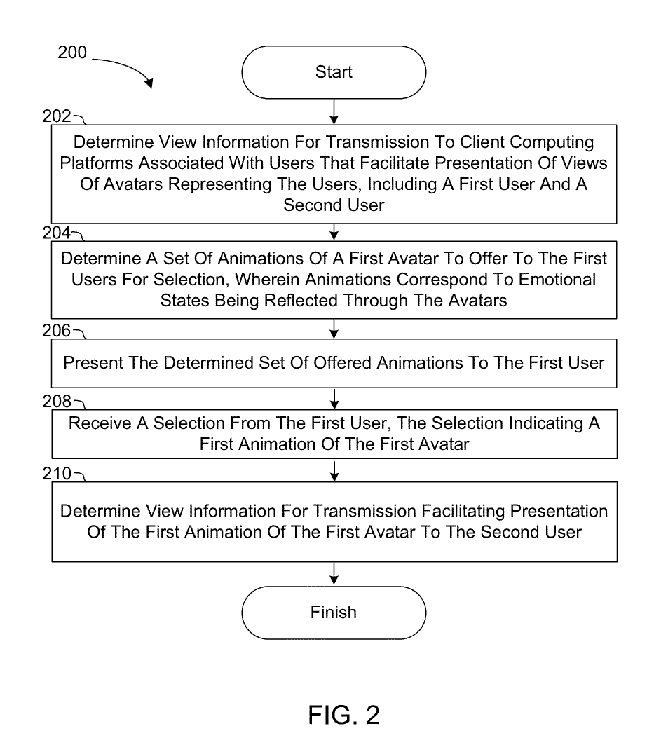

FIG. 2 illustrates a method 200 for reflecting emotional states of users through avatars. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At an operation 202, view information for transmissions to client computing platforms associated with users is determined, the transmissions facilitating presentation of views of avatars representing the users. The users comprise a first user and a second user, the first user being represented by a first avatar. In some embodiments, operation 202 is performed by a virtual space module similar to or substantially the same as virtual space module 22 (shown in FIG. 1 and described herein).

At an operation 204, a set of animations of the first avatar to offer to the first user for selection by the first user is determined. Individual ones of the animations correspond to emotional states being reflected through the avatars. In some embodiments, operation 204 is performed by an offer module similar to or substantially the same as offer module 23 (shown in FIG. 1 and described herein).

At an operation 206, the first user is presented with the determined set of offered animations of the first avatar for selection by the first user. In some embodiments, operation 206 is performed by an offer module similar to or substantially the same as offer module 23 (shown in FIG. 1 and described herein).

At an operation 208, a selection is received from the first user, the selection indicating a first animation of the first avatar. In some embodiments, operation 208 is performed by a selection module similar to or substantially the same as selection module 24 (shown in FIG. 1 and described herein).

At an operation 210, responsive to receipt of the selection of the first animation of the first avatar, view information is determined for transmission to the client computing platform associated with the second user, the transmission facilitating presentation of the first animation of the first avatar to the second user. In some embodiments, operation 210 is performed by a virtual space module similar to or substantially the same as virtual space module 22 (shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation. For example, through a combination of learning from prior manually selected animations and explicit user configuration, the animations for a particular avatar may be autonomously selected to reflect a mostly extrovert personality type, a silly mood, and a hyper-active energy level, prone to performing elaborate celebratory dance routines with other avatars.

What is claimed is:

1. A system configured to reflect emotional states of users through avatars, the system comprising:
one or more processors configured to execute computer program modules comprising:
a virtual space module configured to determine view information for transmissions to client computing platforms associated with users, wherein the transmissions facilitate presentation of views of avatars representing the users, wherein the users comprise a first user and a second user, and wherein the first user is represented by a first avatar;
an offer module configured to determine a set of animations of the first avatar to offer to the first user for selection by the first user, wherein individual ones of the animations correspond to different emotional states being reflected through the avatars, wherein the offer module is further configured to present the first user with the determined set of offered animations of the first avatar for selection by the first user; and
a selection module configured to receive a selection by the first user, the selection indicating a first animation of the first avatar from the determined set of offered animations,
wherein, responsive to receipt of the selection of the first animation of the first avatar, the virtual space module is further configured to determine view information for transmission to the client computing platform associated with the second user, wherein the transmission facilitates presentation of the first animation of the first avatar to the second user.

2. The system of claim 1, wherein avatars depict anthropomorphic characters having bodies and heads.

3. The system of claim 1, wherein the virtual space module is further configured to determine view information that facilitates presentation of views of a virtual space, the system further comprising:
an analysis module configured to analyze transactions and/or events within the virtual space, wherein the analysis module is further configured to determine a set of animations of the avatars based on analysis of the transactions and/or events, and wherein the offer module is configured to determine a set of animations of the first avatar to offer to the first users for selection by the first user based on a determination by the analysis module.

4. The system of claim 3, wherein analysis of the analysis module is based on prior selections by the first user.

5. The system of claim 4, wherein the analysis of the analysis module is further based on an algorithm that heuristically predicts a likelihood of selection of individual animations of the first avatar.

6. The system of claim 5, wherein presentation of at least some of the determined set of offered animations of the first avatar by the offer module is ordered based on the predicted likelihood by the analysis module.

7. The system of claim 1, wherein the received selection indicates a first animation of the first avatar in a subset of animations of the first avatar, wherein individual ones of the animations in the subset have a characteristic pertaining to personality type in common.

8. The system of claim 7, wherein the selection module is further configured to autonomously select animations of avatars, such that animations of the first avatar are autonomously selected from the subset of animations of the first avatar.

9. The system of claim 8, wherein the selection module is further configured to receive a level selection by the first user, the level selection indicating how often animations of the first avatar are selected autonomously.

10. A computer-implemented method for reflecting emotional states of users through avatars, the method being implemented in a computer system comprising one or more processors configured to execute computer program modules, the method comprising:
determining view information for transmissions to client computing platforms associated with users, the transmissions facilitating presentation of views of avatars representing the users, wherein the users comprise a first user and a second user, the first user being represented by a first avatar;
determining a set of animations of the first avatar to offer to the first user for selection by the first user, wherein individual ones of the animations correspond to emotional states being reflected through the avatars;
presenting the first user with the determined set of offered animations of the first avatar for selection by the first user;
receiving a selection from the first user, the selection indicating a first animation of the first avatar; and
determining, responsive to receipt of the selection of the first animation of the first avatar, view information for transmission to the client computing platform associated with the second user, the transmission facilitating presentation of the first animation of the first avatar to the second user.

11. The computer-implemented method of claim 10, wherein avatars depict anthropomorphic characters having bodies and heads

12. The computer-implemented method of claim 10, wherein determining view information for transmissions to client computing platforms associated with users includes determining view information that facilitates presentation of views of a virtual space, the method further comprising:
performing an analysis of transactions and/or events within the virtual space;
accomplishing a determination of an offered set of animations of the avatars based on the performed analysis,
wherein determining a set of animations of the first avatar is based on the accomplished determination.

13. The computer-implemented method of claim 12, wherein the analysis is based on prior selections by the first user.

14. The computer-implemented method of claim 13, wherein the analysis is further based on an algorithm that heuristically predicts a likelihood of selection of individual animations of the first avatar.

15. The computer-implemented method of claim 14, wherein the presentation of at least some of the determined set of offered animations of the first avatar for selection by the first user is ordered based on the predicted likelihood of selection.

16. The computer-implemented method of claim 10, wherein receiving the selection by the first user indicates a first animation of the first avatar in a subset of animations of the first avatar, wherein individual ones of the animations in the subset have a characteristic pertaining to personality type in common.

17. The computer-implemented method of claim 16, further comprising:
autonomously selecting animations of avatars such that animations of the first avatar are autonomously selected from the subset of animations of the first avatar.

18. The computer-implemented method of claim 17, further comprising:
receiving a level selection from the first user, the level selection indicating how often animations of the first avatar are selected autonomously.

19. A non-transient computer readable storage medium having stored thereon computer-readable instructions configured to cause one or more processors to execute a method for reflecting emotional state of users through avatars, the method being implemented in a computer system comprising one or more processors configured to execute computer program modules, the method comprising:
determining view information for transmissions to client computing platforms associated with users, the transmissions facilitating presentation of views of avatars representing the users, wherein the users comprise a first user and a second user, the first user being represented by a first avatar;
determining a set of animations of the first avatar to offer to the first user for selection by the first user, wherein individual ones of the animations correspond to different emotional states being reflected through the avatars;
presenting the first user with the determined set of offered animations of the first avatar for selection by the first user;
receiving a selection from the first user, the selection indicating a first animation of the first avatar; and
determining, responsive to receipt of the selection of the first animation of the first avatar, view information for transmission to the client computing platform associated with the second user, the transmission facilitating presentation of the first animation of the first avatar to the second user.
